(19) United States
(12) Patent Application Publication
(10) Pub. No.: US 2008/0008983 A1
(43) Pub. Date: Jan. 10, 2008

(54) SYSTEM AND METHOD FOR RESOLVING CONFLICT

(76) Inventor: Barbara R. Wright, Laguna Beach, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/563,326

(22) Filed: Nov. 27, 2006

Related U.S. Application Data
(60) Provisional application No. 60/830,047, filed on Jul. 10, 2006.

(51) Int. Cl. G09B 19/00

(52) U.S. Cl. 434/236

(57) ABSTRACT

Provided herein is a system and method for resolving conflict. The method includes the steps of providing a board having a plurality of rows and a plurality of columns that cooperate to define a plurality of positions, defining an intention, going to a starting position on the board that corresponds to the intention, moving to another position on the board, and resolving the conflict.

This application claims the benefit of U.S. Provisional Application No. 60/830,047, filed Jul. 10, 2006, which is herein incorporated by reference in its entirety.

A portion of the disclosure of this patent document and/or the materials provided in the appendix attached hereto contains material that is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### FIELD OF THE INVENTION

The present invention relates generally to systems and methods used by individuals or groups of individuals for resolving conflict.

### BACKGROUND OF THE INVENTION

In everyday life people encounter conflict with others. Many people are not skilled at resolving those conflicts, which results in stress or tension in relationships, between people, and within individuals. Accordingly, a need exists for a system and method for resolving conflicts that reduces stress and tension in relationships and within individuals.

### SUMMARY OF THE PREFERRED EMBODIMENTS

In accordance with a first aspect of the present invention, there is provided a method of resolving conflict. The method includes the steps of providing a board having a plurality of rows and a plurality of columns that cooperate to define a plurality of positions, defining an intention, going to a starting position on the board that corresponds to the intention, moving to another position, and resolving the conflict.

In accordance with a first aspect of the present invention, there is provided a method of resolving conflict between a first person and a second person. The method includes the steps of providing a board having a plurality of rows and a plurality of columns that cooperate to define a plurality of positions, defining an intention of the first person, defining an intention of the second person, prompting the first person to go to a starting position on the board that corresponds to the intention of the first person, prompting the second person to go to a starting position on the board that corresponds to the intention of the second person, wherein the first person and the second person have at least two columns between them, illustrating the conflict, prompting the first and second persons to discuss the issues regarding the intentions and move on the board correspondingly until they have one or less columns between them, and resolving the conflict.

### BRIEF DESCRIPTION OF THE DRAWINGS

FIG. 1 shows an example of a Metta board as used in the system and method for resolving conflict according to the present invention;

FIG. 2 is a flow chart outlining an exemplary embodiment of a system and method for resolving conflict;

FIG. 3 is an example embodiment of the Metta board as used in one example scenario demonstrating unskillful interaction without the Metta process;

FIG. 4 is an example embodiment of the Metta board as used in another example scenario demonstrating skillful interaction using the Metta process; and

FIG. 5 is an example of a game card or score pad for use with the board of FIG. 1.

### DETAILED DESCRIPTION OF THE PREFERRED EMBODIMENTS

For simplicity and clarification, the operating principles, design factors, and layout of the systems and methods for resolving conflict according to this invention are explained with reference to various exemplary embodiments. The basic explanation of the operation of the systems and methods for resolving conflicts is applicable for the understanding and design of the constituent components employed in the systems and methods for resolving conflicts of this invention.

Furthermore, for the sake of simplicity, the terms user, participant and/or individual will be used. It should be understood that the terms user, participant and/or individual(s) are not limited to an individual user processing or resolving his/her conflict(s), but can also include anyone using the systems and methods of this invention to assist one another including teams or groups.

Additionally, it should be understood that although the various exemplary embodiments described herein are described with reference to exemplary methods being in the form of a process and/or game, the systems and methods of this invention can be used in many different manners, such as, for example, software programs, group sessions, board games, television shows, radio broadcasts, internet sites, lectures, continuing education classes, DVD training modules, workbooks, journals, corporate seminars, classrooms, interactive CD-ROM or DVD's, computer-based training, newsletters, blogs and the like.

The terms Metta, Metta system and Metta process will be used throughout the description to refer to the system and process described herein. Metta is a Pali word meaning loving kindness for all.

The fundamental principle underlying Metta is the concept of “free will.” Intention is free will in action. By cultivating skill indiscerningone's intention, one can become more skillful in all life situations and find greater peace in mind, heart and total being. This process is both intellectual and phenomenological—using mental and all sensory and cellular memory. The purpose of the Metta process is to define a conflict and/or intention and then be able to resolve the situation using a method based on kindness and compassion free from shame, blame, or guilt.

Critical elements in this method are integrity, an understanding that all things are impermanent, and being free from attachment to an outcome.

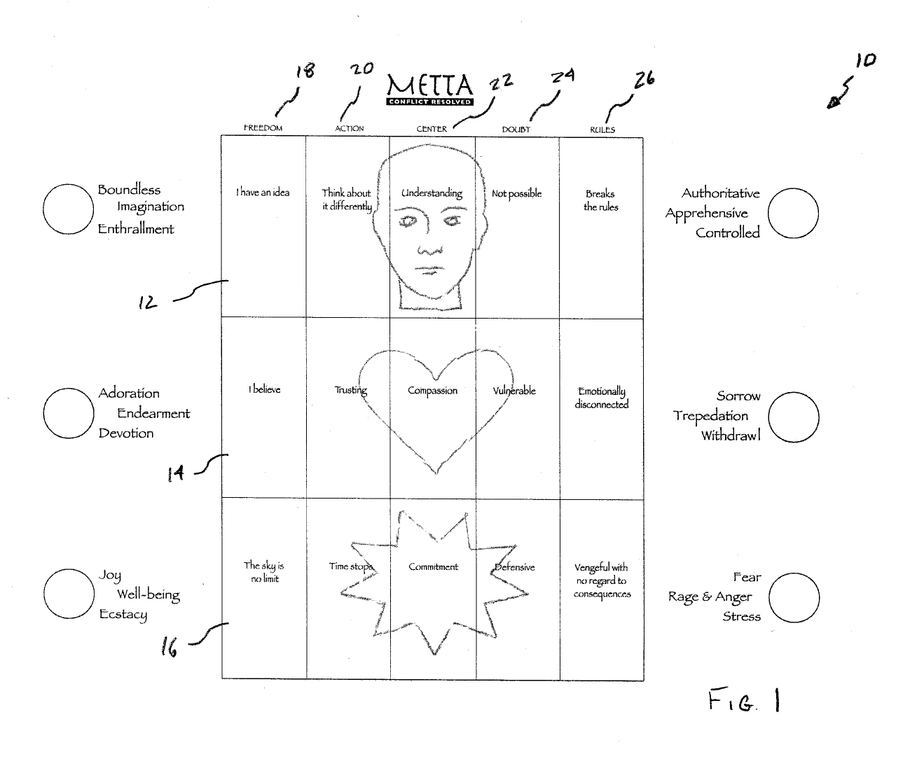

FIG. 1 shows a board or map for aiding in performing the system and method for resolving conflict. The board will be referred to herein as the Metta board 10. In a preferred embodiment, the Metta board's configuration is a map with 15 squares or positions. However, this is not a limitation on the present invention. The board can have any number of positions. In using the board, a user consciously learns to use free will to reach beyond stimulus/response which opens the user up to skillful living through imagination and creative processes.

In a preferred embodiment, the board includes three horizontal rows; the mind intelligence row 12 (also referred to herein as the mind row), the heart intelligence row 14 (also referred to herein as the heart row), and the energy intelligence row 16 (also referred to herein as the energy row).

Intelligence, in Metta, is the ability to take in and process or express information. The Metta system provides for three levels of intelligence; mind, heart and energy. Mind intelligence is intellect, the part of our being that manipulates our thoughts. Heart intelligence is emotional knowledge, the essence of our humanity for good or ill. Energy intelligence is the processing of emotion before words, an affective force. Examples of energy intelligence include DNA, intuition, spirit, imagination and the like.

In a preferred embodiment, the board 10 also includes five vertical columns, which each represent the five states of being in the Metta process. As shown in FIG. 1, the board includes the freedom column 18, action column 20, center column 22, doubt column 24 and rules column 26. The freedom column 18 represents freedom from fear. The action column 20 represents a joyful expression of the moment. The center column 22 represents the neutral zone, an equanimous state free from fear or judgment with access to both sides of the board. The doubt column 24 represents a cautionary state of awareness. The rules column 26 represents limitations based on fear.

The Metta board 10 provides a clearly labeled map of signposts. These signposts help users learn how to skillfully navigate conflict to resolution. The fifteen positions on the Metta board 10 each include a word or phrase therein that represents the relationship between intelligence (the rows) and state of being (the columns) at that point.

In a preferred embodiment, the fifteen positions on the board are “I have an idea,” “think about it differently,” “understanding,” “not possible,” “breaks the rules,” “I believe,” “trusting,” “compassion,” “vulnerable,” “emotionally disconnected,” “the sky is no limit,” “time stops,” “commitment,” “defensive,” and “vengeful with no regard to consequences.” The first five are in the mind intelligence row 12, the second five are the heart intelligence 14 row and the third five are in the energy intelligence row 16.

The following is a brief description of the fifteen positions on the Metta board. “I have an idea” represents the mind's process in the absence of fear, when it is unconstrained. “Think about it differently” represents a cognitive shift that gives a sense of expansion. “Understanding” represents being able to see things differently and see the limitations of the situation. “Not possible” represents being aware of impending consequences and how one's behavior may affect others as well as oneself. “Breaks the rules” represents being challenged by rigid expectations and consequences. “I believe” represents when the heart is wide open and unfettered. “Trusting” represents an assured reliance on some person or thing. “Compassion” represents the ability to feel joy and sorrow for self and others. “Vulnerable” represents when one is capable of being wounded and is defenseless against injury. “Emotionally disconnected” represents when the heart is emotionally isolated and encapsulated. “The sky is no limit” represents when a person feels joy and ecstasy beyond words. “Time stops” represents deep absorption so that it seems to the user like time does not exist. “Commitment” represents the driving force to carry out an action. “Defensive” represents a primal state in which, when threatened, one feels the need to protect. “Vengeful” represents a reflexive response to a perceived threat by the primitive brain (amygdala) with no regard to consequences.

None of the fifteen positions on the board 10 are good or bad in and of themselves. As described below, it is the users applied intention and how skillfully they are expressed that determines the consequences of compassion or stress.

The process of using the Metta board 10 and system is unique to each user's situation. Its flexibility allows it to be intra as well as interpersonal for a multitude of applications.

The right side of the board (the rules column 26 and the doubt column 24) is governed by fear. The left side (the freedom column 18 and the action column 20) is driven by the absence or freedom from fear. The center column 22 is the neutral (equanimous) zone, which is free from fear or judgment and has access to both sides of the board. As described below, in resolving a conflict, by using the board 10, the user(s) aim is to end up in the center column 22. However, this is not always the case. The optimal situation is for the user(s) to move fluidly through the center column 22, keeping an open mind about other internal and external forces, while resolving the conflict.

In a preferred embodiment, the Metta board 10 includes gradually changing shades of color in the various columns. For example, the mind row 12 can be yellow, the heart row 14 can be blue and the energy row 16 can be red. Within each column, the positions in the rows can be different shades of the color. For example, the mind row 12/freedom column 18 position can be light yellow and the mind row 12/rules column 26 position can be dark yellow, with gradually changing yellow shades in between.

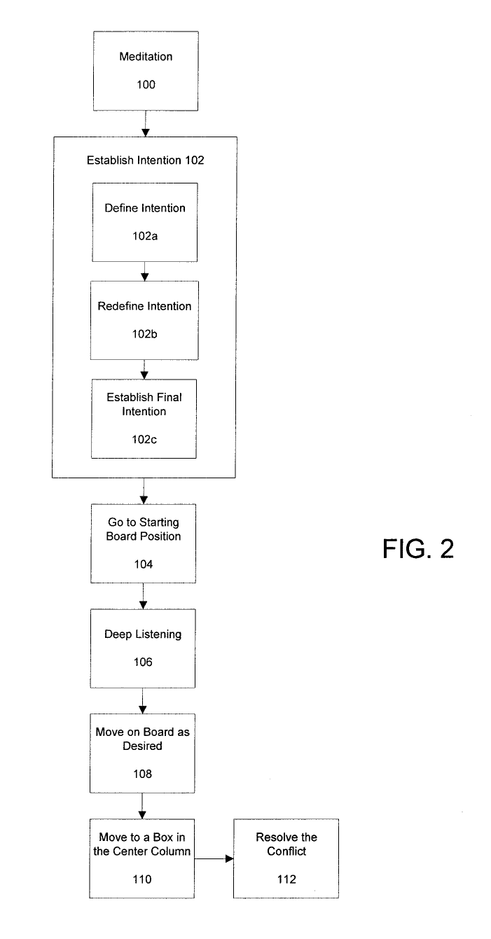

With reference to FIG. 2, an example for using the Metta board 10 will now be described. The example below is for a guided or coached interaction using a Metta board 10 that is large enough to be placed on the floor so that a person can walk on it. It will be understood that any size Metta board 10, whether it be table top, wallet or purse sized or floor sized, can be used.

The users begin with a few moments of breath meditation (step 100) where they simply quiet their minds and follow their breath.

Next, the users must establish their intentions (step 102). In a preferred embodiment, this is done by having the user define his/her intention (step 102a), redefine his/her intention (step 102b) and then establish the intention behind that, which is the final intention (step 102c). By defining and redefining the intention at least three times, the user will be able to find as clear and precise a statement of their intention as possible. For example, we'll use a conflict between a little boy that wants to go to the roof of his house and jump off so that he can fly, and his mother, who tells him that he can't because he'll get hurt. The boy's first intention is to be Superman. In redefining and better understanding his intention the boy states that he wants to be Superman so that he can have super powers. In a final redefinition he determines that he wants to be Superman so that he can fly. The mother's intentions after redefinition are: commitment to the son's safety, compassion for son's imagination and for their relationship.

After establishing their intentions, the users then walk (or move, in the case of a table top board) to the positions on the board that best describe their state of mind (step 104). The boy has an idea that he wants to fly, so he walks to “I have an idea.” The mother thinks that since humans can't fly that the idea of flying breaks the rules, so she walk to “breaks the rules.” In a scenario where the users are using a coach to help them through the exercise, the trained coach may help them establish their positions on the board.

The next step is deep listening (step 106). In a scenario with a coach, the coach asks each Metta Participant (MP) to speak without interruption about the conflict. When they are done the coach can ask them to “Tell me more,” to reveal more information. The coach can keep asking until the MP or MPs have fully revealed their understanding at this time. One must also look at non-verbal communication, such as the MP's posture, body position, hand motions, etc. Deep listening involves listening to one's tone of voice or the other person's tone, the cadence, the sound of the patterns as well as the words chosen.

Next, the coach asks (or the MP asks themself) “Where would you like to go next?” (part of step 108). In this step, the MPs are attempting to work toward the center of the board. At this point the coach and MPs must use their own heart, mind and spirit energy. The general idea is to move to the next space that feels most meaningful to the MP. When an MP is unsure where to move, the coach may suggest moving one or two degrees, or to a different level of intelligence, or request a Metta moment: an agreed upon time out with the intention of returning to the process with more clarity. It is also possible to revisit the intention steps. Maybe the MP's intention has changed in the course of traversing the board.

Next, the MPs continue on the Metta board (part of step 108) until the MPs are feeling that they understand and feel content with their degree of commitment with that intention (step 110). As can be seen in FIG. 1, commitment, is a box located in the center column 22 and at least one of the participants has moved to a position in the center column 22. At this point, the MPs have potentially resolved the conflict (step 112). It should be understood that the optimum condition is to be in the centered positions on the board for Mind (understanding), Heart (compassion) and Energy (commitment) with fluid access to all other states.

It should be understood that the actions that can be performed by the system for resolving conflict of this invention are not limited to the actions listed above. Those skilled in the art will be able to make modifications to the system and method to arrive at the desired outcome.

In a preferred embodiment, the process can include another step known as sealing. In this step, each person moves down the center column 22 and states their understanding, compassion and commitment of the resolution that has been reached at this time.

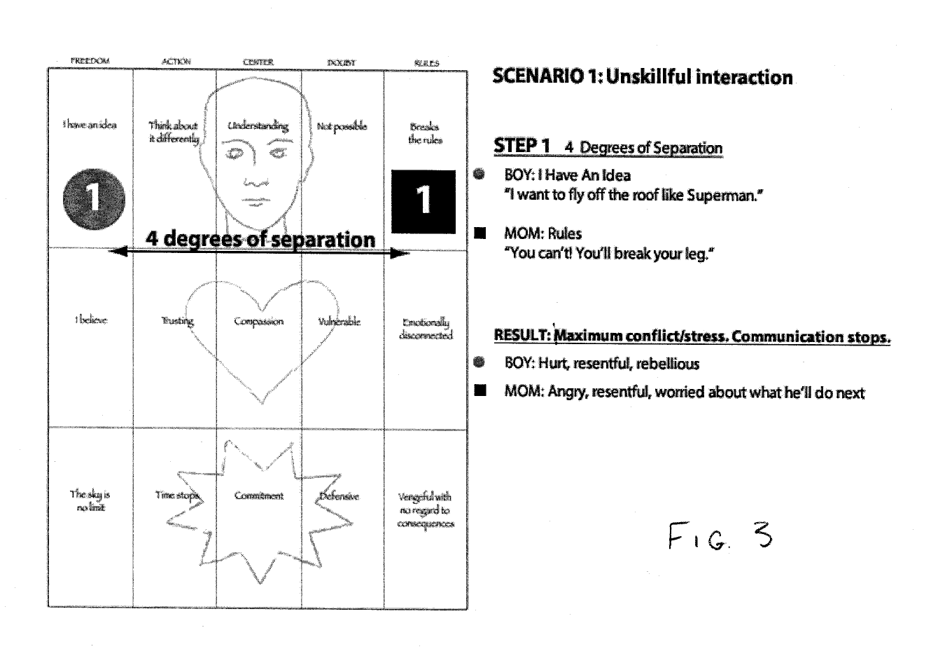

It will be understood, that once the MPs have established their positions on the board they may be separated by an amount of columns. This is known as the degree of separation. For example, in FIG. 3, it can be seen that the boy and mother are separated by four columns, which is four degrees of separation. In another example, if one MP started at “I believe” and another MP started at “Defensive,” there would be three degrees of separation between them. It does not matter what row they are in, only how many columns separate them.

The degrees of separation represent how much stress or tension there is between the two MPs. One degree of separation represents very little tension and ready access to resolution and one another. Two degrees of separation represents stress and tension that could escalate or dissolve, and therefore requires thoughtful consideration of the elements.

Three degrees of separation represents stress and tension that is quite apparent. In this state, one must consider the effect that is being generated. Where is the pressure now (head, heart, energy)? The MPs and/or coach must see how they can reduce the pressure there by talking through it.

Four degrees of separation represents severe stress. The only resolution, if one stops here, is forgiveness, which is an agreement to have no further punishment or consequences. This condition is dangerous and can lead to deception of self and others. With four degrees of separation one is out of Metta. In this state it is imperative to attempt to move towards the center to relieve conflict stressors. This may be achieved through understanding the situation better (Mind), finding Compassion (Heart), revisiting the Commitment (Energy) or looking at the intention. This opens up the possibility of creative movement towards resolution. In step 108, the MPs are attempting to reduce the degrees of separation between them by moving toward the center of the board.

As stated above, the optimum condition is for both MPs (or a single MP in a scenario where one person is trying to resolve a personal conflict) to be in the center column 22. However, it should be understood that if two MPs can come within two degrees of separation of one another, they have resolved some conflict. If at least one of the MPs makes it to the center column 22 the furthest the two MPs can be from one another is two degrees of separation.

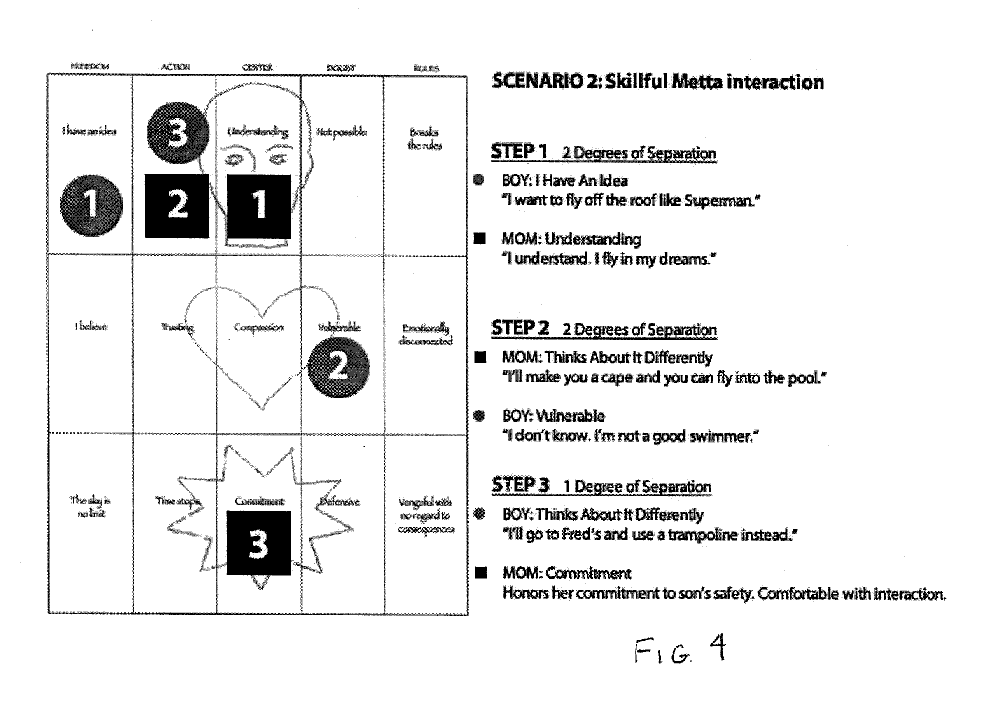

With reference to FIGS. 3 and 4 and continuing with our mother/son example, an example of unskillful interaction and skillful interaction using the Metta board 10 will now be shown.

After completing steps 100-104, as described above, the mother and son have four degrees of separation between them, as shown in FIG. 3, which results in the maximum amount of stress and conflict between them. If they were to stop communicating at this point, there would be no resolution between them, the boy would be hurt, resentful and rebellious, since he didn't get any explanation from the mother other than “No, you can't jump because it will break the rules.” And, the mother would feel angry, resentful and worried about what he'll do next. This is an unskillful, non-Metta interaction.

Referring now to FIG. 4, a skillful interaction that results in a resolution of the conflict (step 112) using the Metta board 10 is shown. In this example, the mother moves from “Breaks the rules” to “Understanding” by telling her son “I understand, I fly in my dreams, everyone wants to fly.” At this point, there are two degrees of separation between them, and the stress has been reduced.

Next, the mother moves to “Think about it differently” and says “I'll make you a cape and you can fly into the pool.” This may come about through coaching. However, the boy says “I don't know, I'm not a good swimmer.” So the boy moves to “Vulnerable.” However, there are still only two degrees of separation between them as they move toward resolution.

Next, the boy moves to “Think about it differently” and says “I'll go to Fred's and use a trampoline instead.” The mother, comfortable with this idea, moves to “Commitment,” because she wants to honor her commitment to her son's safety. She is showing compassion for his imagination and she wants to maintain a relationship with the son and she now understands as a result of the exercise that if she is hyper critical it can harm the relationship. At this point there is only one degree of separation between them.

Those skilled in the art will understand that success may be measured in steps of any amount or Success by Approximation. In other words, moving closer step-by-step to the desired goal in a thoughtful and skillful way. Non-attachment to the outcome creates gratitude for each step along the way and opens new possibilities to resolution.

As shown in FIG. 1, the board 10 can also include verbal cues around the perimeter of the board that the coach or participants may use to help establish a starting position or a position during movement on the board. However, these do not have to be included. The verbal cues around the perimeter of the board 10 highlight the six extreme states of intelligence, with the rules and freedom columns 26 and 18 being the most extreme states. For example, in the mind row 12/freedom column 18 position the user may feel boundless imagination and/or enthrallment. In the mind row 12/rules column 26 position the user may feel authoritative, apprehensive and/or controlled. In the heart row 14/freedom column 18 position the user may feel adoration, endearment and/or devotion. In the heart row 14/rules column 26 position the user may feel sorrow, trepidation and/or withdrawal. In the energy row 16/freedom column 18 position the user may feel joy, well-being and/or ecstasy. In the energy row 16/rules column the user may feel fear, rage, anger or distress.

Those skilled in the art will understand that forgiveness and reconciliation may be part of resolution in the Metta process. Coming into forgiveness means acknowledging that there will be no further punishment or consequences. Forgiveness on its own, without reconciliation, may be dangerous. It can create pockets of resentment that can surface at a later date. Forgiveness, if required or indicated with reconciliation is to understand and create a new, wholesome agreement with yourself or another to go forward. This completes the Metta process and returns the participants to a clear, stress free state in the center positions of Mind, Heart and Energy with access to all other states.

While navigating the Metta board, certain factors or tools should be kept in mind, such as awareness of internal and external conflict, compassion for self and others, never stand alone means having your resources present in body or spirit and being present to what is real and true as you know it in this moment.

Below, certain critical elements of the Metta process will be set forth. If a user is working alone the following are elements to cultivate. If one is coaching, these elements are essential to skillful coaching.

### Intention

### What is the intention?

### How do we decide on our intentions?

### Can we agree on our intentions?

### Who determines our intentions?

### Compassion

### Do we have compassion for self?

### Do we have compassion for loved ones?

### Do we have compassion for those we are neutral for?

### Do we have compassion for our enemies?

### Impermanence

### How do we know impermanence?

### What is the good, the bad and the neutral of impermanence?

### Fear of impermanence—what does that mean?

### Impermanence does not deny consequences.

### Deep Listening Means

### Listening to words.

### Listening to tone.

### Listening to cadence.

### Listening to rhythm.

### Listening to joy.

### Non-Attachment to Outcome

### Is being open to the unfolding of the Metta process.

### Attachment to Outcome

### Attachment to outcome may blind you to new information

### Attachment to outcome may cause deception

### Attachment to outcome may create selective listening

### Attachment to outcome will cause suffering

### Staying with the Process

### Staying with the process will help you understand how being unskillful can cause harm to yourself and others.

### Staying with the process will create understanding.

### Staying with the process will let one be open to new ideas.

### Staying with the process may reveal the rules that limit a user.

### Staying with the process may reveal the rules that will support a user.

### Staying with the process may release new ideas.

### Staying with the process may cause you to think differently.

### Staying with the process will develop compassion for the user and others.

### Staying with the process will help one recognize their vulnerability.

### Staying with the process may help a user develop trust in oneself and others.

### Staying with the process will help a user understand the nature of his/her commitment

### Staying with the process will help the user cultivate boundless joy.

While navigating the board it is important to keep the following things in mind. Watch and feel the energy of the body. Is this sincere or a game? Where are the hands, are they close or open and reaching? How do your or their feet, are they light and touching in gentle steps or are they hesitant or pounding the map?

Attempt to remain in compassion. Watch the face and receive the expression displayed by the participant. One should feel one's own face while on the board. Is your brow furrowed, are the lips in a smile or are they pursed as if you are chewing on something? Are you pausing and looking around as if to find that missing piece? Once you are skillful at being aware of your own behaviors, your powers of observation will grow, as will your understanding and compassion.

One should be aware of one's breath. How are you breathing when you move to different places on the board 10? Can you feel an energy shift? Can you observe how the other person's energy shifts while on the board?

Become more comfortable with impermanence. One should understand that one can experience how good ideas and old feelings can change and that free will allows for these changes. In becoming skillful with the Metta process one can gain the following benefits: stress reduction, not being lost in anger and helplessness, a calmer demeanor, more creative when problem-solving, more open to input, reduction of violent outbursts, more harmony in the environment, more self-control, less judgmental, reduction of self-destructive behaviors, reduction of time lost due to illness, improved chances for recovery from addiction, improved cognitive processes, improved critical thinking, expanded understanding of opposing thought process, skillful analysis of one's current social situation, skillful analysis of one's historical situation, skillful analysis of personal relationships, skillful analysis of self, development of thoughtful and compassionate remedies, development of a more trusting atmosphere at work, home or in social settings, development of mediation skills, and development of more appropriate social skills, skillful analysis of geopolitical situations, skillful analysis of historical events and skillful literary analysis.

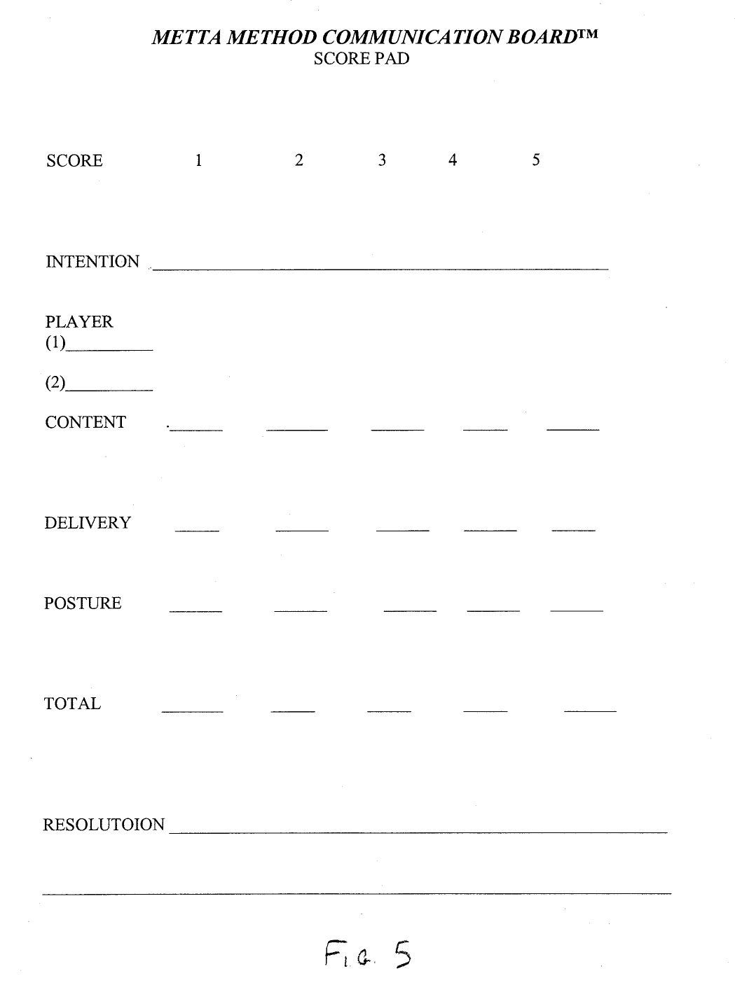

With reference to FIG. 5, in another embodiment, the board 10 can be used as a game board so that the users can be scored on how well they resolve conflict. FIG. 5 shows an exemplary game card or score pad, titled “Metta Method Communication Board,” for playing the game. In the game, the users can score themselves or each other or be scored by third parties (such as a coach) as they work through the steps of the process. As can be seen in FIG. 5, the card includes a space for the MPs intention to be entered. The card also includes spaces for content, delivery and posture to be scored. On the exemplary card, the scoring system is between one and five (with five being the highest and one being the lowest, or vice versa). The card also includes a space for entering the resolution to the conflict.

While the invention has been described above, other aspects and/or features of the invention may be presented in the materials contained in the Appendix, which materials are incorporated herein by reference and are intended to be included in this patent application.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention. Accordingly, the present invention is to be defined solely by the scope of the following claims.

What is claimed is:

1. A method of resolving conflict, the method comprising the steps of:
providing a board having a plurality of rows and a plurality of columns that cooperate to define a plurality of positions,
defining an intention,
going to a starting position on the board that corresponds to the intention,
moving to another position on the board, and
resolving the conflict.

2. The method of claim 1 wherein the board has a center column, and wherein the method further comprises the step of moving to a plurality of positions on the board, wherein at least one of those positions is in the center column.

3. The method of claim 2 wherein the conflict is resolved by moving to a position in the center column.

4. The method of claim 1 wherein the method is performed by a single person.

5. The method of claim 1 wherein the method is performed by a plurality of persons.

6. The method of claim 1 further comprising the step of meditating.

7. The method of claim 1 further comprising the step of redefining the intention.

8. The method of claim 7 further comprising the step of establishing a final intention.

9. A method of resolving conflict between a first person and a second person, the method comprising the steps of:
providing a board having a plurality of rows and a plurality of columns that cooperate to define a plurality of positions,
defining an intention of the first person,
defining an intention of the second person,
prompting the first person to go to a starting position on the board that corresponds to the intention of the first person,
prompting the second person to go to a starting position on the board that corresponds to the intention of the second person, wherein the first person and the second person have at least two columns between them,
prompting the first and second persons to discuss the issues regarding the intentions and move on the board correspondingly until they have one or less columns between them, and
resolving the conflict.

10. The method of claim 9 further comprising the step of prompting the first and second persons to redefine their intentions.

11. The method of claim 9 wherein the board includes a center column.

12. The method of claim 11 wherein at least one of the first and second persons moves into the center column while moving on the board.

13. The method of claim 9 wherein the board is placed on the floor.

14. The method of claim 10 wherein the first and second persons stand on the board.

15. The method of claim 9 wherein the board is placed on a table.

16. The method of claim 10 further comprising the step of prompting the first and second persons to redefine their intentions to establish a final intention.
